(19) United States
(12) Patent Application Publication
(10) Pub. No.: US 2010/0142525 A1
(43) Pub. Date: Jun. 10, 2010

(54) VIRTUAL LANE IDENTIFICATION METHOD AND APPARATUS FOR APPLYING VIRTUAL LANE SCHEME TO OPTICAL TRANSPORT NETWORK

(75) Inventors: Hyun Woo Cho, Daejeon (KR); Yong Wook Ra, Daejeon (KR); Byung Jun Ahn, Daejeon (KR)

Correspondence Address: RABIN & Berdo, PC, 1101 14TH STREET, NW, SUITE 500, WASHINGTON, DC, 20005, US

(73) Assignee: ELECTRONICS AND TELECOMMUNICATIONS RESEARCH INSTITUTE, Daejeon (KR)

(21) Appl. No.: 12/576,038

(22) Filed: Oct. 8, 2009

(30) Foreign Application Priority Data
Dec. 8, 2008 (KR) 10-2008-0124008
Apr. 15, 2009 (KR) 10-2009-0032933

(51) Int. Cl. H04L 12/56

(52) U.S. Cl. 370/389

(57) ABSTRACT

There is provided a virtual lane identification method and apparatus for applying a virtual lane scheme to an optical transport network. More particularly, there is provided a technique for identifying virtual lanes using multi-frame alignment signals (MFASs) at a receiver without modifying an existing frame structure of an optical transport network signal by periodically changing a rotating direction of the virtual lanes when applying an Ethernet virtual lane scheme to a ultra-high speed OTN signal, particularly to OTU4 (100G).

### CROSS-REFERENCE TO RELATED APPLICATIONS

This application claims the priorities of Korean Patent Application Nos. 10-2008-0124008 filed on Dec. 8, 2008, and 10-2009-0032933 filed on Apr. 15, 2009, in the Korean Intellectual Property Office, the disclosures of which are incorporated herein by reference.

### BACKGROUND OF THE INVENTION

1. Field of the Invention

The present invention relates to a virtual lane identification method and apparatus for applying a virtual lane scheme to optical transport networks (OTNs), and more particularly, to a technique for identifying virtual lanes using multi-frame alignment signals (MFASs) within OTN frames at a receiver without modifying the frame structure of existing standardized OTN by periodically changing a rotating direction of the virtual lanes when applying an Ethernet virtual lane scheme to an ultra-high speed OTN signal, particularly to OTU4 (100 G).

2. Description of the Related Art

Recently, attempts to converge Ethernet and optical transport networks (OTNs) have been actively made. In particular, a technique for applying a virtual lane scheme standardized in IEEE standard 802.3ba to an optical transport network is being discussed.

In order to apply an Ethernet virtual lane scheme to ultra-high speed optical transport network signals (OTU3, OTU4 and more), first, a receiver needs to measure skews occurring between different individual lanes during transmission, and second, the receiver needs to identify each virtual lane. In other words, the receiver needs to identify the individual virtual lanes and reassemble the virtual lanes in correct order. To this end, various methods have been proposed.

According to a first method, frame alignment signals (FASs) within the OTN frame are distributed in unit of bit to virtual lanes, and then odd and even bits of the FAS are inverted. Though this method can be applied to OTU3 well, it, however, does not take OTU4 in consideration.

According to a second method, OTU frames are divided in unit of 8-byte blocks, the divided data blocks are distributed to individual virtual lanes, and a “framing block” corresponding to the first 8-byte block of each OTU frame is shifted forward by 8-byte unit. As for OTU3 frames, for example, OTU3 frame structures need to be modified so that the framing blocks are located at the same position every four frames. As a result, framing blocks are evenly distributed to four virtual lanes. However, according to this method, it is impossible to identify each virtual lane by frame alignment signals within the framing block. Therefore, a 1-byte signal, which is a multi-frame alignment signal (MFAS), is located after a frame alignment signal, is used as a virtual lane identifier (VL ID). However, this method needs to modify OTUk frame structure itself by shifting framing blocks by 8 bytes and besides, this method also cannot be applied to OTU4.

A third method improves over the above-described second method. According to the third method, while OTU frames are divided in unit of 8-byte block, and the divided blocks are distributed to individual virtual lanes, the order of virtual lanes are rotated by one lane after finishing a distribution process of one frame, and then a distribution process of the next frame is performed. This method also uses the MFAS as a virtual lane ID for OTU3, but it is impossible to identify the virtual lanes by only MFASs for OTU4.

Furthermore, in order to overcome the problem of the third method, a method of overwriting VL ID information in the last FAS byte has been proposed. That is, VL IDs are generated instead of MFASs and added to a frame before distributing the divided blocks to the virtual lanes. However, this method also requires modifying the OTUk frame structure in order to add the VL IDs to the frame. The VL ID needs to be overwritten in a portion of the frame alignment signal (FAS).

### SUMMARY OF THE INVENTION

An aspect of the present invention provides a virtual lane identification method and apparatus that can identify virtual lanes using multi-frame alignment signals (MFASs) within OTN frames at a receiver without modifying an existing frame structure of an optical transport network signal by periodically changing a rotating direction of the virtual lanes when applying a virtual lane scheme of Ethernet to a ultra-high speed OTN signal, particularly to OTU4 (100 G).

According to an aspect of the present invention, there is provided a virtual lane identification apparatus at a transmitting side, the apparatus including: a framer forming and processing a frame structure of transport data signal; a frame disassembler dividing the frame into blocks of a predetermined size so that one same block contains a frame alignment signal (FAS) and a multi-frame alignment signal (MFAS) within the OTN frame, which is received from the framer; and a lane identification rotating device periodically changing a rotating direction of a plurality of virtual lanes and distributing the blocks divided by the frame disassembler to the plurality of virtual lanes by a round-robin scheme.

The frame disassembler may divide the frame so that one block has a size of 8N (N=1, 2, . . . and 102) bytes.

The lane identification rotating device may include:
a frame distribution unit distributing the blocks divided by the frame disassembler to the plurality of virtual lanes by the round-robin scheme, and then distributing blocks of a next frame to the rotated virtual lanes after finishing distributing all blocks of one frame; a forward rotation unit rotating virtual lanes in a forward direction according to the control of the frame distribution unit; and a reverse rotation unit rotating the order of virtual lanes in a reverse direction according to the control of the frame distribution unit.

The frame distribution unit may determine a rotation period of the virtual lanes so that the number of framing blocks, each including an FAS and an MFAS, on each virtual lane, satisfies the following equation as a result of rotating the entirety of virtual lanes:

(the total number of virtual lanes)≦2^{N} (N is an integer)≦2⁸

For instance, if the total number of virtual lanes is 20, the frame distribution unite may repeatedly operate the forward rotation unit three times and then the reverse rotation unit once, the forward rotation unit four times and then the reverse rotation unit once, the forward rotation unit four times and then the reverse rotation unit once, the forward rotation unit four times and then the reverse rotation unit once, the forward rotation unit four times and then the reverse rotation unit once, the forward rotation unit four times and then the reverse rotation unit once, and then the forward rotation unit three times.

According to another aspect of the present invention, there is provided a virtual lane identification apparatus at a receiving side, the apparatus including: a lane identification device aligning a plurality of received virtual lanes respectively using frame alignment signals (FASs) and identifying the plurality of virtual lanes using sets of multi-frame alignment signals (MFASs); a virtual lane assembler reassembling an original frame of an optical transport network signal from all the virtual lanes having been aligned and identified by the lane identification device; and a framer receiving the frame reassembled by the virtual lane assembler and performing signal processing.

The lane identification device may include: a lane identification processor detecting the FASs with respect to the plurality of virtual lanes, checking an FAS detection period, transmitting virtual lanes having a constant FAS detection period to a first lane identification unit and transmitting virtual lanes having an FAS detection period with a predetermined pattern to a second lane identification unit; the first lane identification unit receiving the virtual lanes having the constant FAS detection period from the lane identification processor, identifying the virtual lane with reference to a lane identification table using sets of MFAS values, and performing lane alignment using the FASs; and the second lane identification unit receiving the virtual lane having the FAS detection period with the predetermined pattern from the lane identification processor, identifying the virtual lane with reference to a lane identification table using sets of MFAS values, and performing lane alignment using the FASs.

According to another aspect of the present invention, there is provided a method of identifying a virtual lane, the method including: receiving a signal in predetermined units and checking a detection period of frame alignment signals (FASs) contained in the input signal; checking whether the detection period and MFAS values contained in the input signal are normal; identifying and aligning virtual lanes when the detection period and the MFAS values are normal; and reassembling the virtual lanes, having been identified and aligned, to output an original frame of an optical transport network signal.

The method may further include generating an error alarm when the detection period of the FASs is neither constant nor has a specific pattern.

The method may further include generating an error alarm when the detection period or the MFAS value is abnormal.

The identifying and aligning of the virtual lanes may include aligning the virtual lanes correctly using the FASs and identifying the virtual lanes using sets of MFAS values through a lookup of a lane identification table.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a structural view illustrating an OTUk (k=1, 2, 3) frame standardized in ITU-T recommendation G.709;

FIG. 2 is a view illustrating a virtual lane scheme introduced in IEEE P802.3ba for 40 GbE and 100 GbE transmission;

FIGS. 3A and 3B are views showing the results of dividing an OTUk frame into groups of blocks of 8 bytes and distributing the groups of blocks to 20 virtual lanes;

FIGS. 4A through 4D are diagrams displaying the results of applying a basic lane rotation scheme according to the related art;

FIG. 5 is a view illustrating a method of overwriting a VL ID for virtual lane identification in a last byte of an FAS according to the related art;

FIGS. 6A through 6C are views illustrating a method of periodically changing a rotating direction of virtual lanes according to an exemplary embodiment of the present invention;

FIG. 7 is a view illustrating the configuration of a virtual lane identification apparatus according to an exemplary embodiment of the present invention; and

FIG. 8 is a flowchart illustrating a virtual lane identification process according to another exemplary embodiment of the present invention.

### DETAILED DESCRIPTION OF THE PREFERRED EMBODIMENT

Exemplary embodiments of the present invention will now be described in detail with reference to the accompanying drawings. The invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, if a portion is considered to unnecessarily divert the gist of the present invention, such portion will be omitted, and the same reference numerals will be used throughout to designate the same or like components.

It will be understood that when an element is referred to as being “connected with” another element, it can be directly connected with the other element or intervening elements may also be present. In contrast, when an element is referred to as being “directly connected with” another element, there are no intervening elements present. In addition, unless explicitly described to the contrary, the word “comprise” and variations such as “comprises” or “comprising,” will be understood to imply the inclusion of stated elements but not the exclusion of any other elements.

The invention is to effectively identify virtual lanes when an Ethernet virtual lane scheme is applied to an ultra-high speed OTN signal, particularly to OTU4 (100 G). The IEEE is likely to standardize that parallel transmission through 20 virtual lanes for 100 GbE. As for OTU4 (100 G), ITU-T is working on standardization to adopt most of the OTU1 to OTU3 frame structures in the art. Therefore, the invention will be described by focusing on a case in which OTU4 is transmitted through 20 virtual lanes.

Before describing the present invention, a structure of an OTUk frame, the concept of a virtual lane scheme and other background art will be described in detail to aid in the understanding of the present invention.

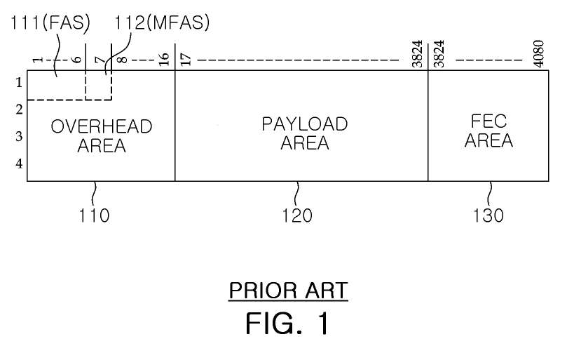

FIG. 1 is a structural view illustrating an OTUk (k=1, 2, 3) frame standardized in ITU-T recommendation G.709. Here, a value k refers to a bit rate or capability. That is, k=1 means 2.5 G, k=2 means 10 G, and k=3 means 40 G. Regardless of the value k, an OTUk frame structure is configured as shown in FIG. 1.

As shown in FIG. 1, an OTUk frame consists of 4080×4 bytes and is clarified into an overhead area 110, a payload area 120 and an FEC area 130, which are respectively located as shown in FIG. 1. Furthermore, a 6-byte frame alignment signal (FAS) 111 is located at a start point of every OTUk frame. A 1-byte multi-frame alignment signal (MFAS) 112 follows the frame alignment signal (FAS) 111.

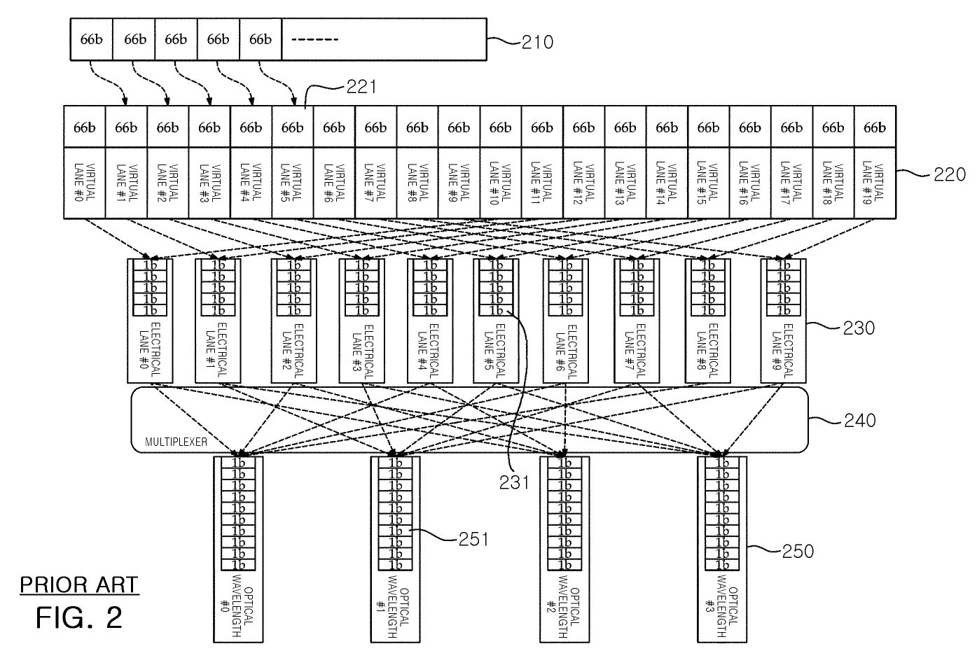

FIG. 2 is a view illustrating a virtual lane scheme introduced in IEEE P802.3ba for 40 GbE and 100 GbE transmission.

First, a 64b/66b encoded 100 GbE signal 210 is split in groups of 20 blocks in units of 66b to thereby generate virtual lanes 220. Here, signal 210 is placed into the virtual lanes 220 according to a round-robin scheme. That is, when a first 66b block is placed into a virtual lane #0, a second 66b block is placed into a virtual lane #1. In this way, the individual blocks are sequentially placed into the 20 virtual lanes 220. A twenty first 66b block is placed into the virtual lane #0.

Then, when there are 10 physical electrical lanes 230, for example, in the case of a system where 10 parallel signals are transmitted across a backplane, the 20 virtual lanes 220 are multiplexed by bit-interleaving and placed into the 10 electrical lanes 230. As a result, each of the electrical lanes 230 has two virtual lanes again.

Then, when there are 4 physical optical lanes 250 for optical transmission, for example, in the case of an optical module that assigns 4 optical wavelengths and performing optical transmission through optical links, a 10:4 multiplexer 240 carries the signals, received through the electrical lanes 230, into the four optical lanes 250 by bit-interleaving.

The optical lanes 250 multiplexed by the above-described process each have five virtual lanes. Note a signal of an arbitrary virtual lane is always transmitted along one specific physical lane. For example, a signal 221 of the virtual lane #5 is only transmitted through a specific electrical lane 231 and a specific optical lane 251. This is because the number of virtual lanes is determined according to the least common multiple of all the physical lanes.

In order to apply this Ethernet virtual lane scheme to an OTN frame, signal alignment information to compensate skews among virtual lanes and lane identifier information to identify virtual lanes are required.

First, as for the lane alignment, apart of OTN overhead may be used. A frame alignment signal (FAS) is placed into a 6-byte area from a start point of an OTUk frame, followed by a 1-byte multi-frame alignment signal (MFAS). If the FAS and the MFAS are grouped into one block and distributed to each virtual lane, then it is able to facilitated for lane alignment.

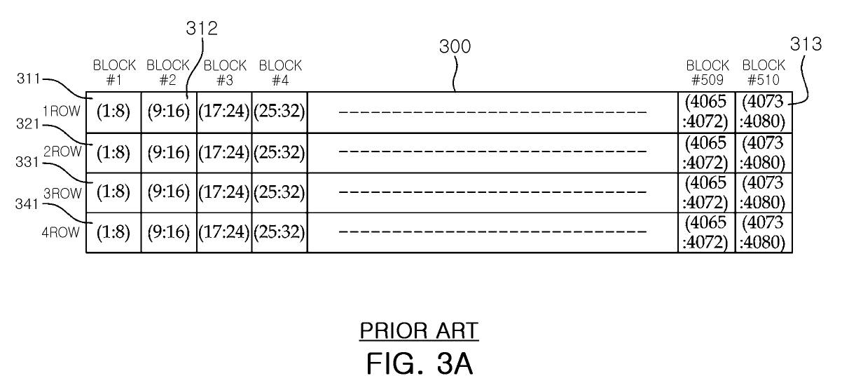

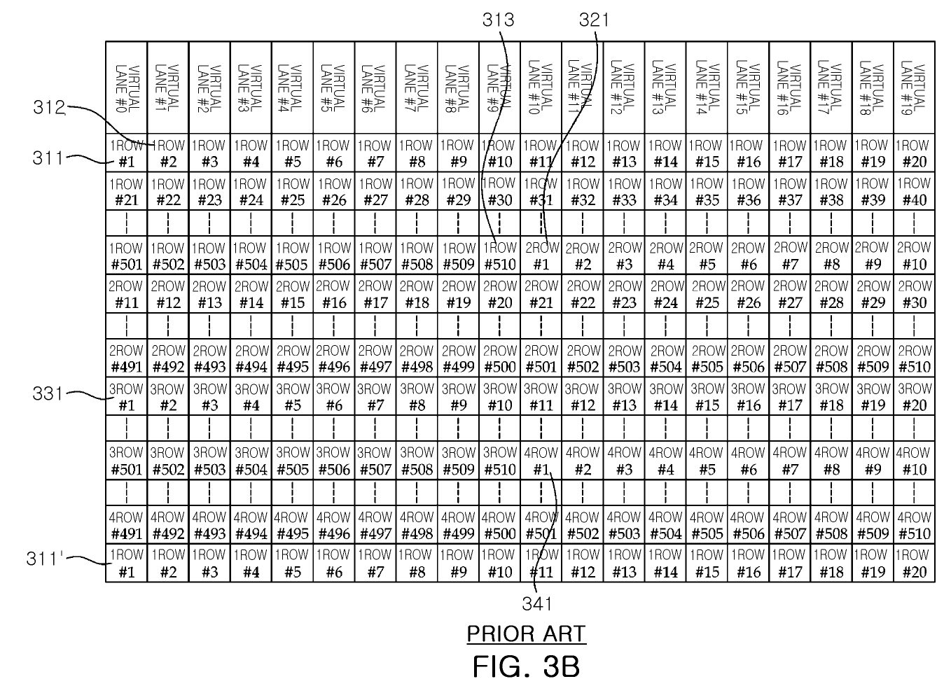

FIGS. 3A and 3B are views showing the results of splitting an OTUk frame in groups of blocks of 8 bytes each and distributing the groups of blocks to 20 virtual lanes.

Specifically, in FIG. 3A, one OTUk frame 300 is split in groups of blocks of 8 bytes. Each block is defined as (n:m), which means a corresponding block ranges from an n-th column to an m-th column of a corresponding row. For example, (1:8) marked on a first block 311 of a first row refers to first to eighth columns in bytes. That is, the first block 311 includes first to eight bytes of the first row. A second block 312 following the first block 311 includes ninth to sixteenth bytes of the first row. The same rule applies to the other blocks. The blocks of the OTUk frame are transmitted left to right, top to bottom. That is, after the final block 313 of the first row is transmitted, a first block 321 of a second row is transmitted.

In FIG. 3B, the groups of the blocks of the OTUk frame are distributed by a round-robin scheme to 20 virtual lanes. As such, when the OTUk frame is split in the groups of blocks of 8 bytes from the start point of the OTUk frame, and the groups of blocks are distributed by the round-robin scheme to the 20 virtual lanes, a block corresponding to the start point of the OTUk frame (hereinafter, referred to as a “framing block”) is assigned, in their entirety, to one lane. A total of 2040 blocks, including the framing block, are equally divided and distributed to the 20 virtual lanes.

In FIG. 3B, though the framing block 311 is placed into the virtual lane #0, the location of the framing block has not any restriction. That is, the framing block 311 can be placed into any other virtual lane. Similarly, though one block has an 8-byte size in FIGS. 3A and 3B, one block may have a size of 8N (N=1, 2, and 102) bytes for the OTU frame structure. Only rule about the block size is that seven successive bytes (FAS and MFAS) from the start point of the OTU frame are included in one block.

However, as shown in FIG. 3B, if the groups of blocks are distributed to the virtual lanes in order, the framing blocks 311 and 311′ are always placed into the same lane. Therefore, in order to align the virtual lines using the framing blocks, they need to be evenly distributed across the individual virtual lanes.

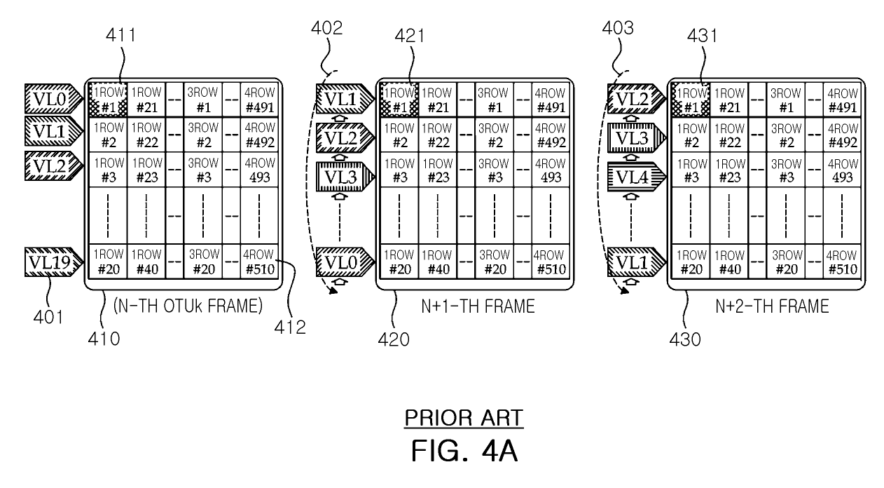

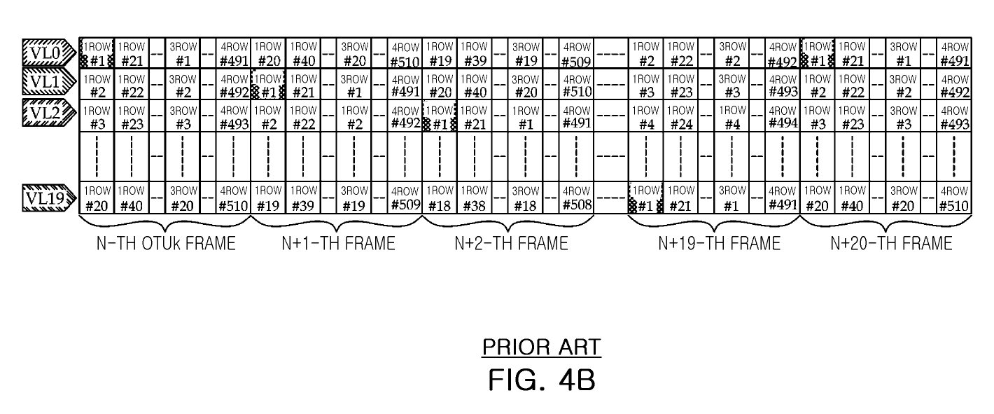

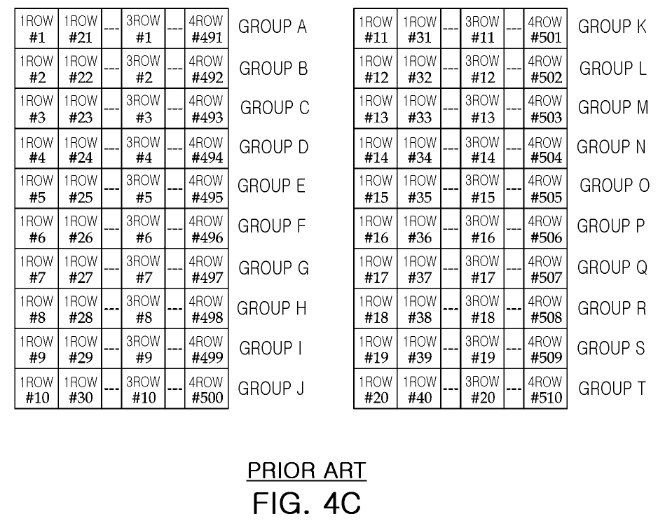

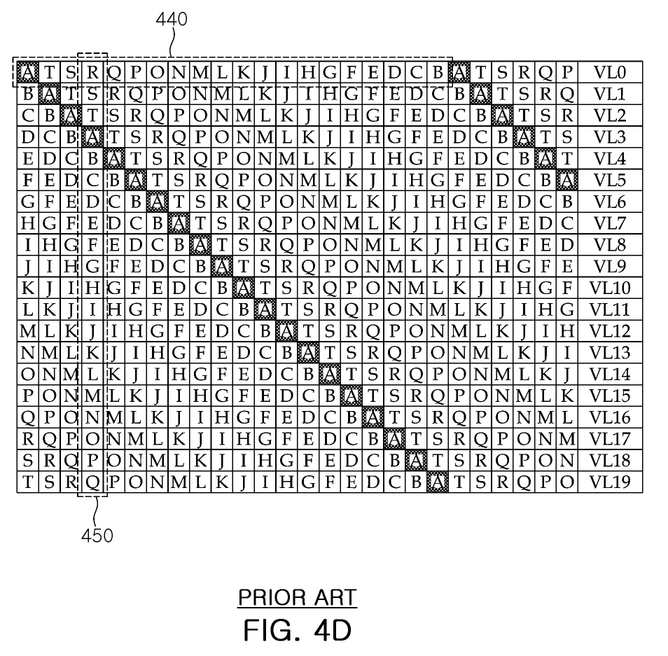

FIGS. 4A through 4D are diagrams displaying the results of applying a basic lane rotation scheme according to the related art.

Referring to FIG. 4A, when three sequential OTUk frames 410, 420 and 430 are split in groups of blocks of 8 bytes each, and the groups of blocks are distributed to 20 virtual lanes, the virtual lanes are rotated by one lane after lane distribution for one OTUk frame is completed. That is, when a first block of an arbitrary N-th OTUk frame 410 is distributed to a virtual lane #0 (VL0), blocks of an N+1-th OTUk frame 420 are distributed to virtual lanes 402 in which virtual lanes 401 are rotated by one lane. As a result, a framing block 421 of the corresponding frame 420 is placed into a virtual lane VL1 rather than a virtual lane VL0. Likewise, blocks of an N+2-th OTUk frame 430 are distributed to virtual lanes 403 in which the virtual lanes 402 are rotated by one lane, so that a framing block 431 of the corresponding frame 430 is placed into a virtual lane VL2.

FIG. 4B is a view showing the results of equally dividing 20 successive OTUk frames and distributing the OTUk frames to virtual lanes. Referring to FIG. 4B, when signals of the individual virtual lanes are combined on the basis of framing blocks, it is shown to have a similar structure to an OTUk frame structure.

FIG. 4C is a view showing the results of reconfiguring 20 groups of different blocks, placed into respective virtual lanes, using Latin characters A to T for convenient to explain. One OTUk frame contains the letters from A to T only one time each. When one frame is split in groups of blocks of 8 bytes, one group consists of and 102 8-byte blocks.

FIG. 4D illustrates the extended concept of FIG. 4B. When a group including a framing block is denoted by A, blocks A are shifted back by one position and are placed into 20 virtual lanes. Furthermore, on the time axis of an arbitrary OTUk frame, that is, in a vertical direction, the block A is necessarily present in each one of the virtual lanes. Therefore, this lane rotation scheme is useful for lane alignment since it allows even distribution of FASs to respective virtual lanes. However, the basic lane rotation scheme, described with reference to FIGS. 4A through 4D, does not work in identifying virtual lanes.

Meanwhile, since the OTUk frame includes an MFAS used to identify a multi-frame, a method of identifying virtual lanes using the MFASs may be considered. When OTUk frames are spilt in groups of blocks of 8 bytes, MFASs are evenly distributed to the respective virtual lanes in the same manner as FASs since MFASs also belong to framing blocks. If the number of virtual lanes is a power of 2, that is, 2^{N}, where N is a natural number, it is possible to identify virtual lanes using MFASs. For example, when there are four virtual lanes, a framing block appears once every four OTUk frames in each of the virtual lanes. Here, the MFAS value increments by 4, and each of the virtual lanes includes a set of different MFAS values. Since the MFAS value ranges from 0 to 255 in a sequential order, when four virtual lanes are rotated using a basic lane rotation scheme, each of the virtual lanes has the MFAS values corresponding to one among the following four sets:
{4N}, {4N+1}, {4N+2}, {4N+3} (N=0,1,2, . . . and 63)

Therefore, it is possible to simply identify virtual lanes using MFAS values.

However, if the number of virtual lanes is not a power of 2, it is impossible to identify a virtual lane using an MFAS value. For example, if there are 20 virtual lanes, distribution results according to the basic lane rotation scheme are as follows:
L0 {0, 20, 40, 60, 80 . . . 220, 240, 4, 24 . . . }
VL1 {1, 21, 41, 61, 81 . . . 221, 241, 5, 25 . . . }
VL2 {2, 22, 42, 62, 82 . . . 222, 242, 6, 26 . . . }
VL3 {3, 23, 43, 63, 83 . . . 223, 243, 7, 27 . . . }
VL4 {4, 24, 44, 64, 84 . . . 224, 244, 8, 28 . . . }
VL19 {19, 39, 59, 79, 99 . . . 239, 3, 23, 43 . . . }

Therefore, it becomes impossible to identify virtual lanes using MFAS values alone.

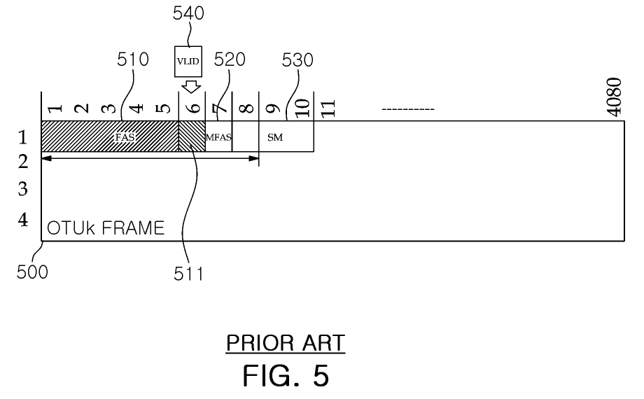

FIG. 5 is a view illustrating a method of overwriting a VL ID (Virtual Lane Identifier) used to identify a virtual lane in the last byte of FAS according to the related art. When a frame is split in groups of blocks of 8 bytes, a receiver can easily process signals if frame alignment information and VL ID information are contained in first 8 bytes of an OTUk frame 500. Here, the first 8 bytes of the OTUk frame 500 consist of a 6-byte FAS 510, a 1-byte MFAS 520 and a portion of a section monitoring (SM) signal 530 of an OTUk overhead period. Among them, since the MFAS and the SM signal must be used for a dedicated purpose after the receiver reassembles the OTUk frame, they cannot be overwritten. Therefore, the last byte of the 6 bytes of the FAS that has relatively few usages is overwritten with the VL ID.

Upon analysis of techniques for virtual lane identification in the related art, other approaches are also available.

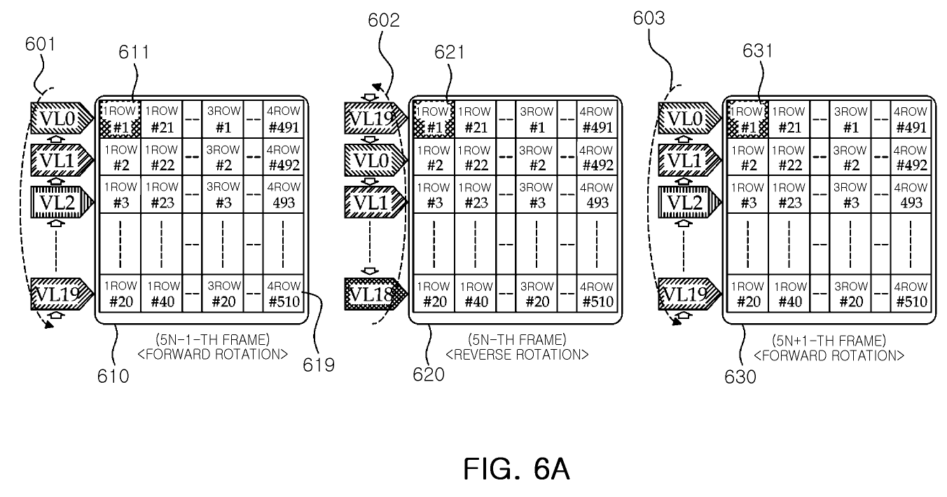

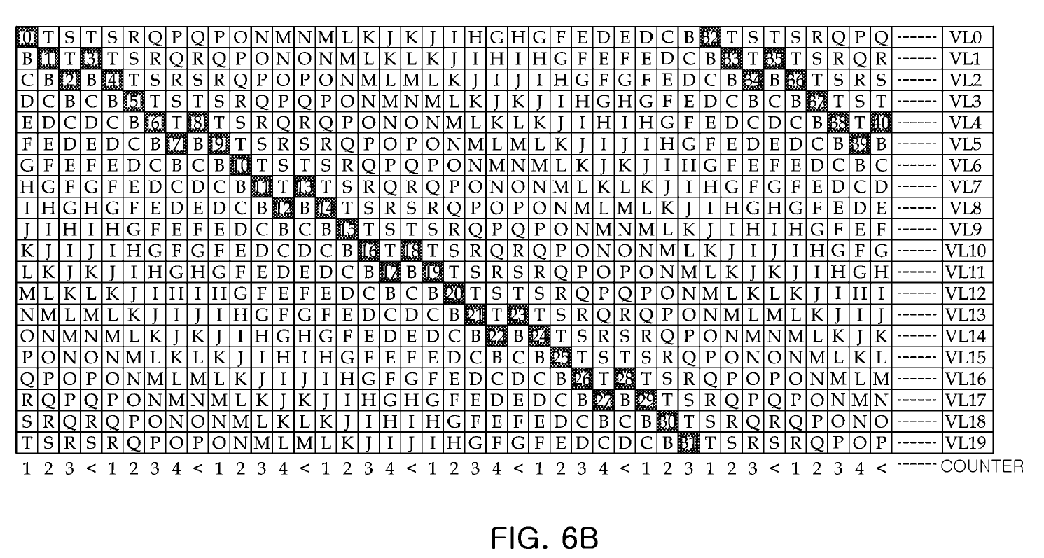

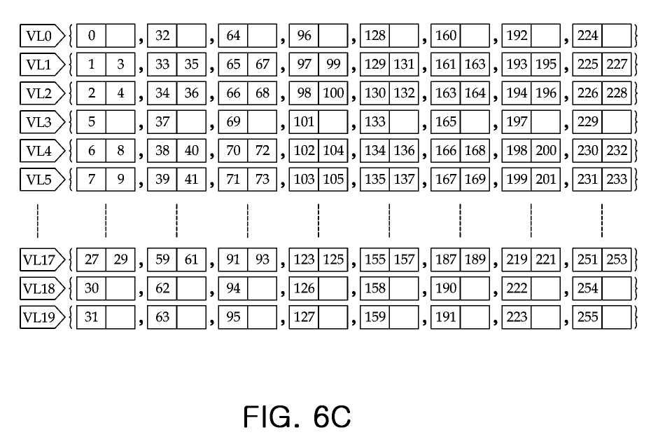

According to a first method, an OTUk frame structure standardized in by ITU-T is modified such that a portion thereof is specified for a VL ID. That is, this method is a combination of the lane rotation scheme, described with reference to FIG. 4A, and the method of overwriting a VL ID, described with reference to FIG. 6. However, this method needs to allow the use of a portion of an FAS for another purpose (VL ID).

According to a second method, the number of virtual lanes for 100 GbE in IEEE P802.3ba is determined in favor of OTUk frame structure. That is, when the number of virtual lanes is determined as a multiple of 4 instead of 20, as described above, an MFAS can be used as a virtual lane ID without modifying an OTU4 frame structure. However, if the two standardization organizations try to make things better for their own signals or try not to modify a frame structure, there is a need for a distribution method without modifying an OTU4 frame structure.

FIGS. 6A through 6C are views illustrating a method of periodically changing a rotating direction of virtual lanes according to an exemplary embodiment of the invention.

According to this embodiment, as shown in FIG. 6A, virtual lanes are rotated in a forward direction for n sequential OTUk frames (601), the virtual lanes are then rotated in a reverse direction for the next one OTUk frame (602), and the virtual lanes with respect to m sequential OTUk frames are rotated in a forward direction (603). Here, n and m are natural numbers and may be adjusted according to the total number of virtual lanes. The values n and m are adjusted so that the number of framing blocks input to the respective virtual lane can be a power of 2 after all the virtual lanes are rotated.

FIG. 6B shows the results of distributing groups of the OTUk frame to virtual lanes using Latin characters indicating OTUk frame portions, defined in FIG. 4C. A group A is a group of an OTUk frame including framing blocks. In FIG. 6B, one example of MFAS values is shown at a position of the group A. As such, the rotating direction of the virtual lanes is changed according to a periodical pattern “6-4-4-4-4-4-6-4- . . . ”, so that 265 MFAS values (0 to 255) can be distributed to the 20 virtual lanes to have independent sets. The rotating direction changing period, described with reference to FIG. 6B, corresponds to one example. The rotating direction changing period of the virtual lanes may be changed according to the number of virtual lanes and a virtual lane rotation order.

FIG. 6C is a view illustrating a group in which MFAS values are only extracted when virtual lanes are rotated as shown in FIG. 6B. Unlike the related art, a unique set of MFAS values appears in a specific virtual lane. Therefore, according to this embodiment, it is possible to identify virtual lanes using MFASs at a receiver after the frame is transported, without overwriting an extra VL ID at a transmitter or modifying the OTUk frame structure.

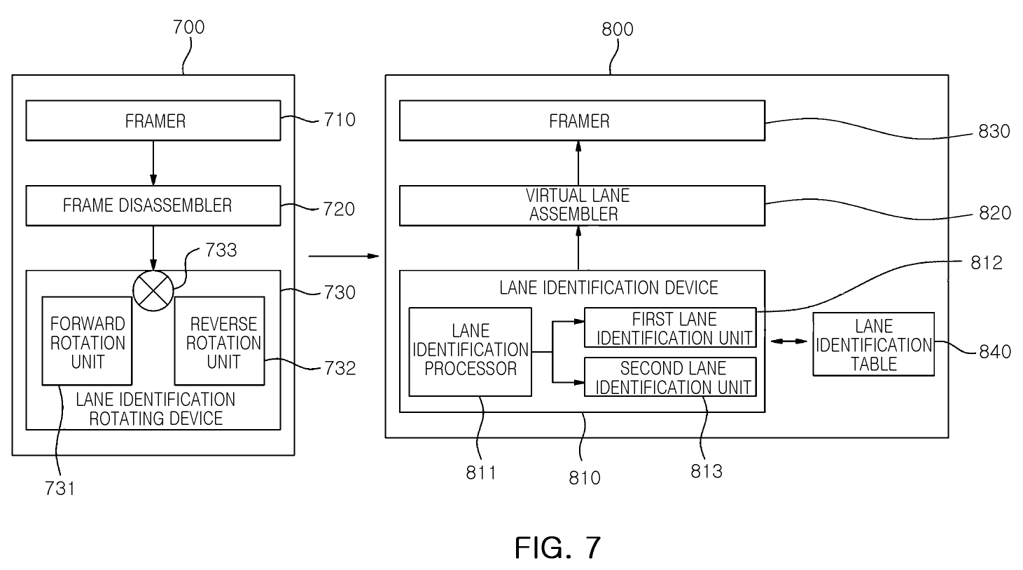

FIG. 7 is a view illustrating the configuration of a virtual lane identification apparatus according to an exemplary embodiment of the invention. The virtual lane identification apparatus includes a virtual lane identification apparatus at a transmitting side 700 and a virtual lane identification apparatus at a receiving side 800. The virtual lane identification apparatus at the transmitting side 700 distributes a frame (for example, an OTUk frame) of an optical transport network signal by periodically changing a rotating direction of virtual lanes. The virtual lane identification apparatus at the receiving side 800 aligns, identifies and reassembles the virtual lines to recover an original frame of the optical transport network.

The virtual lane identification apparatus at the transmitting side 700 includes a framer 710, a frame disassembler 720 and a lane identification rotating device 730.

The framer 710 forms and process generic frames of optical transport network signals. Since a commercial framer chip, which is widely known in the art, may be used for the framer 710, a detailed description thereof will be omitted.

The frame disassembler 720 disassembles the frame into blocks of a predetermined size so that an FAS and an MFAS of an OTUk frame to be transmitted are included in one block. Here, the frame disassembler 720 may disassemble the OTUk frame so that one frame block has a size of 8N (N=1, 2, . . . and 102) bytes.

The lane identification rotating device 730 periodically changes the rotating direction of the virtual lanes and distributes the blocks, disassembled by the frame disassembler 720, to a plurality of virtual lanes according to a round-robin scheme.

Specifically, the lane identification rotating device 730 includes a forward rotation unit 731, a reverse rotation unit 732 and a frame distribution unit 733.

The forward rotation unit 731 and the reverse rotation unit 732 rotate the virtual lanes in a forward direction and a reverse direction, respectively, which are controlled by the frame distribution unit 733.

The frame distribution unit 733 distributes the frame blocks, disassembled by the frame disassembler 720, to the plurality of virtual lanes according to a round-robin scheme. Here, when the frame distribution unit 733 finishes distributing all blocks of one OTUk frame, the frame distribution unit 733 continues distributing blocks of the next OTUk frame after rotating the order of the virtual lanes by one lane.

Note the frame distribution unit 733 does not rotate the virtual lanes toward one way but periodically changes the rotating direction of the virtual lanes. To this end, the frame distribution unit 733 determines a rotation period of the virtual lanes according to the number of virtual lanes and controls the forward rotation unit 731 and the reverse rotation unit 732 according to the rotation period.

The frame distribution unit 733 may determine the rotation period of the virtual lanes so that the number of framing blocks, each containing an FAS and an MFAS, which is distributed to all the virtual lanes, as a result of rotating procedure about the entire virtual lanes, the number of framing blocks on each virtual lane satisfies the following equation for the OTN frame:

(the total number of virtual lanes)≦2^{N} (N is an integer)≦2⁸

For example, if there are 20 virtual lanes, as shown in FIG. 6B, the frame distribution unit 733 repeatedly operates the forward rotation unit 731 three times, the reverse rotation unit 732 once, the forward rotation unit 731 four times, the reverse rotation unit 732 once, the forward rotation unit 731 four times, the reverse rotation unit 732 once, the forward rotation unit 731 four times, the reverse rotation unit 732 once, the forward rotation unit 731 four times, the reverse rotation unit 732 once, the forward rotation unit 731 four times, the reverse rotation unit 732 once, and then forward rotation unit 731 three times. As a result of rotating the entirety of virtual lanes with respect to each one of the virtual lanes, 32(=2⁵) framing blocks are distributed over the entirety of virtual lanes.

Meanwhile, the virtual lane identification apparatus at the receiving side 800 includes a lane identification device 810, a virtual lane assembler 820 and a framer 830.

The lane identification device 810 aligns virtual lanes using the FASs of the respective virtual lanes, and identifies the virtual lanes according to sets of MFAS values.

Specifically, the lane identification device 810 includes a lane identification processor 811, a first lane identification unit 812 and a second lane identification unit 813.

The lane identification processor 811 detects FASs on each of the virtual lanes, checks a period in which the FASs are detected, transmits virtual lanes having a constant FAS detection period to the first lane identification unit 812, or transmits virtual lanes having not a constant period but a specific pattern of a FAS detection period to the second lane identification unit 813.

The first lane identification unit 812 processes virtual lanes having a constant period in which FASs are detected. The second lane identification unit 813 processes signals having a period with a specific pattern in which FASs are detected. The first lane identification unit 812 and the second lane identification unit 813 identify the individual virtual lanes using sets of MFAS values through a lookup of a lane identification table 840, and align the virtual lanes using the FASs. Here, the lane identification table 840 is configured beforehand and stores the predetermined patterns (both constant and specific) of FAS detection periods and corresponding sets of MFAS values.

The virtual lane assembler 820 reassembles the original frame (for example, an OTUk frame) of the optical transport network signal from all the virtual lanes having been aligned and identified by the lane identification device 810.

The framer 830 forms and processes frames of optical transport network signals. A commercial framer chip, which is widely known in the art, may be used as the framer 830. Thus, a detailed description thereof will be omitted.

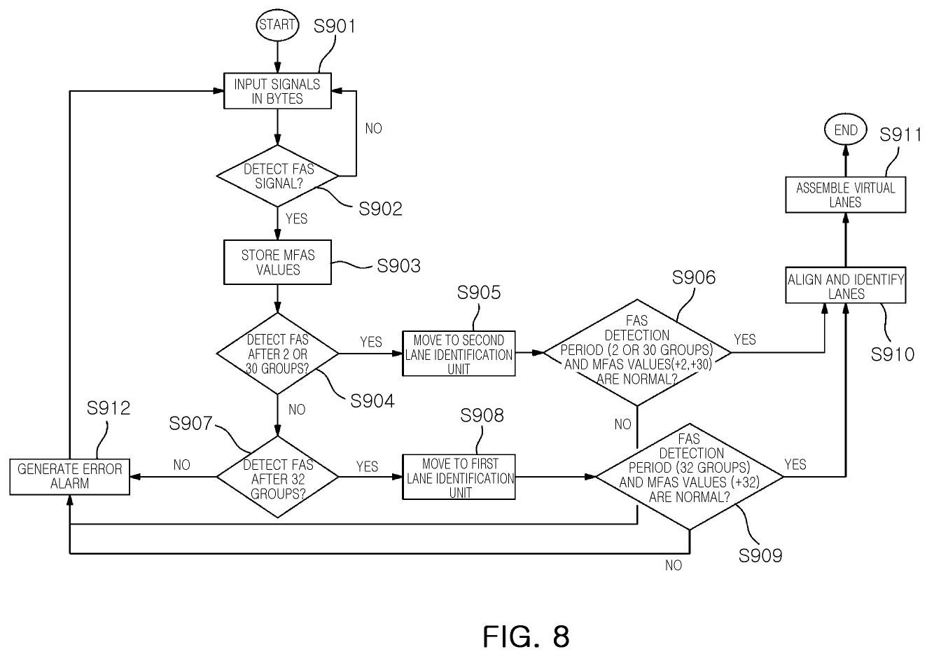

FIG. 8 is a flowchart illustrating a process of identifying a virtual lane according to another exemplary embodiment of the invention. In FIG. 8, a lane identification process is shown in which an OTUk frame is divided into groups of blocks of 8 bytes and the groups of blocks are mapped over 20 virtual lanes.

First, a signal is input in units of 8 bytes at operation S901, and it is checked whether the input signal is an 8-byte group including the bit patterns of ‘F6F6F6282828_{HEx}’ which is the FAS pattern defined in ITU-T Recommendation G.709. If the FAS is not detected as the checking result, the operation S901 is repeated.

If the FAS is detected at operation S902, an MFAS value corresponding to 1 byte that follows the FAS is stored at operation S903. Then, it tried to find the next FAS pattern through checking signal in unit of 8-byte group.

If an interval between a first FAS and a second FAS is 2 times or 30 times of group at operation S904, the corresponding virtual lane is transferred to the second lane identification unit at operation 905. On the other hand, when the interval is 32 groups at operation S907, the corresponding virtual lane is transferred to the first lane identification unit at operation S908. When the interval does not correspond to 2 groups, 30 groups and 32 groups, an error alarm is generated at operation S912. Here, a 1 group corresponds to a group unit, described with reference to FIG. 4C, that is, and 102×8 bytes.

Then, the first lane identification unit processes a virtual lane in which an FAS and an MFAS appear every 8×102×32 bytes. After checking whether an FAS detection period and MFAS values are normal values at operation S909, the first lane identification unit corrects skews using the FASs and identifies the virtual lanes through a lookup of the lane identification table at operation S910. On the other hand, when the FAS detection period or the MFAS value is abnormal, that is, if the FAS detection period is not 32-group or the MFAS value is not increment by 1, the first lane identification unit generates an error alarm at operation S912. Then, the procedure returns back to the operation S901 of the lane identification process.

On the other hand, the second lane identification unit processes a virtual lane in which an FAS and an MFAS appear every 8×51×2 bytes and 8×51×30 bytes. First, the second land identification unit checks whether an FAS detection period and MFAS values are normal values at S906, corrects skews using the FASs and identifies the virtual lanes through a lookup of the lane identification table at S910. However, when the FAS detection period or the MFAS values are abnormal, that is, if the period is neither 2 nor 30 times of group or the MFAS value is not increment by 1, the second lane identification unit generates an error alarm at S912. Then, the procedure returns back to the operation S901 of the lane identification process.

Then, the virtual lane assembler sequentially reassembles the virtual lanes having been aligned and identified by the first lane identification unit or the second lane identification unit to thereby output the frame of the optical transport network signal at operation S911.

As set forth above, according to exemplary embodiments of the invention, a receiver can identify and align virtual lanes using the MFAS without modifying a standard frame structure of ultra-high speed OTUk (e.g. OTU4 and more).

Accordingly, virtual lane identification is possible by adding a simple circuit for changing a rotating direction of the virtual lanes to an OTUk and/or an Ethernet transceiver module according to the related art, thereby getting cost-effective solution and compatibility between an ultra-high speed optical transport network and Ethernet.

While the present invention has been shown and described in connection with the exemplary embodiments, it will be apparent to those skilled in the art that modifications and variations can be made without departing from the spirit and scope of the invention as defined by the appended claims.

What is claimed is:

1. A virtual lane identification apparatus at a transmitting side, the apparatus comprising:
a framer forming and processing a frame structure of transport data signal;
a frame disassembler dividing the frame into blocks of a predetermined size so that a frame alignment signal (FAS) and a multi-frame alignment signal (MFAS) of the frame received from the framer are contained in one same block; and
a lane identification rotating device periodically changing a rotating direction of a plurality of virtual lanes and distributing the blocks divided by the frame disassembler to the plurality of virtual lanes by a round-robin scheme.

2. The apparatus of claim 1, wherein the frame disassembler divides the frame so that one block has a size of 8N (N=1, 2, . . . and 102) bytes.

3. The apparatus of claim 1, wherein the lane identification rotating device comprises:
a frame distribution unit distributing the blocks divided by the frame disassembler to the plurality of virtual lanes by the round-robin scheme, and then distributing blocks of a next frame to the rotated virtual lanes after finishing distributing all blocks of one frame;
a forward rotation unit rotating virtual lanes in a forward direction according to the control of the frame distribution unit; and
a reverse rotation unit rotating the virtual lanes in a reverse direction according to the control of the frame distribution device.

4. The apparatus of claim 3, wherein the frame distribution unit determines a rotation period of the virtual lanes so that the number of framing blocks, each including an FAS and an MFAS, on each virtual lane satisfies the following equation as a result of rotating the entirety of virtual lanes:
(the total number of virtual lanes)≦2^{N} (N is an integer)≦2⁸

5. The apparatus of claim 4, wherein the frame distribution unit repeatedly operates the forward rotation unit three times and then the reverse rotation unit once, the forward rotation unit four times and then the reverse rotation unit once, the forward rotation unit four times and then the reverse rotation unit once, the forward rotation unit four times and then the reverse rotation unit once, the forward rotation unit four times and then the reverse rotation unit once, the forward rotation unit four times and then the reverse rotation unit once, and then the forward rotation unit three times when there are 20 virtual lanes.

6. A virtual lane identification apparatus at a receiving side, the apparatus comprising:
a lane identification device aligning a plurality of received virtual lanes respectively using frame alignment signals (FASs) and identifying the plurality of virtual lanes using sets of multi-frame alignment signals (MFASs);
a virtual lane assembler reassembling an original frame of an optical transport network signal from all the virtual lanes having been aligned and identified by the lane identification device; and
a framer receiving the frame reassembled by the virtual lane assembler and performing signal processing.

7. The apparatus of claim 6, wherein the lane identification device comprises:
a lane identification processor detecting the FASs with respect to the plurality of virtual lanes, checking an FAS detection period, transmitting virtual lanes having a constant FAS detection period to a first lane identification unit and transmitting virtual lanes having an FAS detection period with a predetermined pattern to a second lane identification unit;
the first lane identification unit receiving the virtual lanes having the constant FAS detection period from the lane identification processor, identifying the virtual lane with reference to a lane identification table using a set of MFAS values, and performing lane alignment using the FASs; and
the second lane identification unit receiving the virtual lanes having the FAS detection period with the predetermined pattern from the lane identification processor, identifying the virtual lane with reference to a lane identification table using sets of MFAS values, and performing lane alignment using the FASs.

8. A method of identifying a virtual lane, the method comprising:
receiving a signal in predetermined units and checking a detection period of frame alignment signals (FASs) contained in the input signal;
checking whether the detection period and MFAS values contained in the input signal are normal;
identifying and aligning virtual lanes when the detection period and the MFAS values are normal; and
reassembling the virtual lanes, having been identified and aligned, to output an original frame of an optical transport network signal.

9. The method of claim 8, further comprising generating an error alarm when the detection period of the FASs is neither constant nor has a specific pattern.

10. The method of claim 8, further comprising generating an error alarm when the detection period or the MFAS value is abnormal.

11. The method of claim 8, wherein the identifying and aligning of the virtual lanes comprises aligning the virtual lanes using the FASs and identifying the virtual lanes using sets of MFAS values through a lookup of a lane identification table.
